(19) United States
(12) Patent Application Publication
(10) Pub. No.: US 2008/0319824 A1
(43) Pub. Date: Dec. 25, 2008

(54) MARKET-BASED CONTINUOUS QUALITY FUNCTION DEPLOYMENT TOOL AND METHOD OF USE

(75) Inventors: Steven Eric Linthicum, Lake In The Hills, IL (US); Christina Ann LaComb, Schenectady, NY (US)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 11/765,044

(22) Filed: Jun. 19, 2007

(51) Int. Cl. G06F 17/00; G06Q 99/00

(52) U.S. Cl. 705/10

(57) ABSTRACT

Certain embodiments of the present invention provide methods and system for gathering feedback regarding clinical software features and/or functionality in a virtual market model. Certain embodiments include allowing one or more authorized users to submit one or more clinical software items for trading in a virtual market; facilitating trading of the one or more clinical software items by one or more authorized users via the virtual market; and generating feedback regarding the one or more clinical software items based on trading data. Certain embodiments include a virtual market facilitating trading of one or more clinical software items by one or more users and a user interface allowing a user to submit one or more software items for trading via the virtual market and allowing a user to trade shares of one or more clinical software items to indicate an opinion regarding one or more clinical software items.

### BACKGROUND OF THE INVENTION

The present invention generally relates to gathering customer feedback for software development. In particular, the present invention relates to use of a market-driven model to collect customer input for software development.

Software applications, including clinical software for patient and/or practice management, are becoming popular in clinical settings, such as hospitals, clinics and doctors offices. Software running on general purpose and specialized computer systems allows a variety of software packages and upgrades to be installed and executed for users.

During a define portion of a software development cycle, a list of features/functionality that will be provided in an upcoming iteration of software are down-selected from a list of all required/desired features/functionality. Typically, selection of features/functionality is done with input from a Quality-Function-Deployment (QFD) tool by which a software development team can elicit desired features and their relative importance. Selection is typically done as a one-time-process. Further, this selection process is difficult (if not impossible) to do with an extensive and geographically dispersed set of users.

QFD provides a flexible group decision-making technique allowing a company, customer market segments and/or technology development needs to generate graphs, matrices for use in product/service development. Using QFD, customer needs and opinions may be transformed into engineering characteristics and tests for a product or service. QFD feedback may be used to select one or more product/service configurations and development marketing strategies and tactics for those product(s) and/or service(s).

A tool is needed that allows for a large, geographically dispersed customer base to provide information to software vendors regarding the relative importance of features and functionality. A tool allowing customers to consider the importance of individual features while comparing the importance of those features to other users would be highly desirable. A tool providing an environment in which the software vendor can emphasize the opinions of select subsets of the end-users based (e.g., on their annual sales, expertise, or other differentiating factor) would be highly desirable.

Previously, information markets have only been used to measure customer preferences and predict continuous measures. QFDs are currently used as static documents, completed at a set point in time prior to a software development cycle and captured by surveys and interviews. The extension of preference markets for use as continuous real-time QFDs where QFD importance is derived from trading behavior and market prices would be highly desirable.

Therefore, a need exists for systems and methods for collecting customer input in a market-based model for guidance in clinical software development and marketing. A need exists for systems and methods for analysis of customer input in a market-based model for guidance in clinical software development and marketing.

### BRIEF SUMMARY OF THE INVENTION

Certain embodiments of the present invention provide methods and system for gathering feedback regarding clinical software features and/or functionality in a virtual market model.

Certain embodiments provide a method for gathering user feedback regarding a plurality of clinical software options in a virtual market model. The method includes allowing a plurality of authorized users to each submit one or more clinical software items to form a plurality of clinical software items for trading in a virtual market. The method also includes facilitating trading of one or more clinical software items by at least the plurality of authorized users via the virtual market. The method further includes generating feedback regarding a relative popularity of the plurality of clinical software items based on comparative trading data for each of the plurality of clinical software items.

Certain embodiments provide a virtual market trading system for evaluating clinical software features and functionality. The system includes a virtual market facilitating trading of one or more clinical software items by one or more authorized users. The system also includes a user interface allowing an authorized user to submit one or more software items for trading via the virtual market and allowing an authorized user to trade shares of the one or more clinical software items to indicate an opinion regarding a relative value of the one or more clinical software items.

Certain embodiments provide a computer-readable medium having a set of instruction for execution on a computer. The set of instructions includes a virtual market trading routine providing one or more clinical software items for trading in a virtual market and facilitating trading of the one or more clinical software items by one or more authorized users via the virtual market. The set of instructions also includes a user interface routine allowing one or more authorized users to trade shares of one or more clinical software items and allowing one or more authorized users to add and/or remove one or more clinical software items from the virtual market. The set of instructions also includes a feedback routine generating feedback regarding the one or more clinical software items based on trading data.

Certain embodiments provide an information market system for evaluating ideas relating to clinical functionality. The system includes a virtual market facilitating evaluation of ideas relating to clinical functionality through trading of the ideas by one or more authorized users. The ideas traded on the virtual market are submitted by one or more authorized users. The system also includes a user interface allowing an authorized user to submit ideas relating to clinical functionality and to trade shares of the ideas to indicate an opinion regarding a relative value of the ideas.

### BRIEF DESCRIPTION OF SEVERAL VIEWS OF THE DRAWINGS

FIG. 1 illustrates a clinical QFD system for gathering customer feedback regarding software features/functionality in accordance with an embodiment of the present invention.

FIG. 2 illustrates an exemplary user interface display for market-based evaluation of software features in accordance with an embodiment of the present invention.

FIG. 3 illustrates a flow diagram for a method for ranking software features/functionality using an information market in accordance with an embodiment of the present application.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentality shown in the attached drawings.

### DETAILED DESCRIPTION OF THE INVENTION

Certain embodiments facilitate collection and usage of feedback, such as customer feedback, in software application development and/or packaging. Certain embodiments provide and/or utilize a virtual financial market to elicit voice of customer information. For example, a software vendor and/or other provider may identify a super set of features/functionality that may be included in a new software package and/or future iterations of an existing software package. These features/functionality options are then presented as securities in a virtual financial market. Customers can then trade share(s) based on their preference/priority for the features/functionality. As the market progresses, a volume-weighted-average-price of shares traded provides an aggregated view of an importance of each feature/function for the participating group.

In certain embodiments, customer(s) may suggest new feature(s)/functionality which will then be added as securities on the market. Customers can then “trade on” those securities.

Thus, a group-aggregation function of markets provides systems and methods by which group consensus can be reached in an interactive manner. Participants buy and sell securities based on their preferences. In these markets, the securities are new features or functionality for a new or existing software product. In certain embodiments, market participants can submit their own ideas for entry into the market. Then, participants can buy and sell shares of ideas based on how important they feel the feature/functionality is relative to other features/functionality.

In certain embodiments, a time limit or duration may be placed on a market, and/or a market may be checked periodically and/or after a certain time period. When a market is checked, feature(s)/functionality with, for example, a highest volume-weighted-average-price over a certain period of trading are considered the feature(s)/functionality most/more important to the group. In certain embodiments, a certain predetermined number of feature(s)/functionality may be selected as important or valuable to the target group. For example, five features/functionality with the highest volume-weighted-average-price over the last five days of trading may be designated as important features/functionality. As another example, all feature(s)/functionality with a price over a certain threshold may be designated as important feature(s)/functionality. In certain embodiments, feature(s)/functionality are ranked according to gathered data, and a user and/or automated program may select from the ranked feature(s)/functionality.

In certain embodiments, since the market is operating in real-time or substantially real-time (e.g., with some inherent system processing/communication delay), changes in customer preferences and/or in an environment in which the software feature(s)/functionality are being considered are reflected in market prices. Thus, certain embodiments provide an interactive way for customers to set a vision for software products.

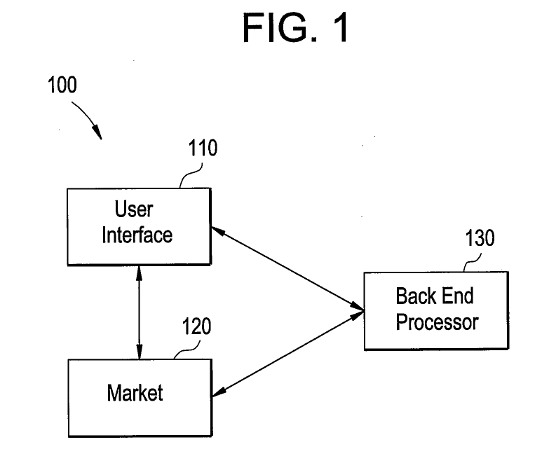

FIG. 1 illustrates a clinical QFD system 100 for gathering customer feedback regarding software features/functionality in accordance with an embodiment of the present invention. The system 100 includes one or more user interfaces 110, a market 120 and a back end processor 130. In certain embodiments, the elements of the system 100 may be implemented separately and/or combined in a variety of combinations. In certain embodiments, the system 100 may be implemented on a single computer, a local or wide area network, over the Internet, via a private network, etc. The components of the system 100 may be implemented in software, hardware and/or firmware, for example.

The user interface 110 allows a user to view current trading information for one or more software features/functionality included in the market 120. Using the interface 110, a customer may “trade” one or more items/ideas and thereby contribute his or her feedback to feature/functionality evaluation. Features, functionality and/or other ideas may be represented as items to be traded on a virtual market 120. A user may “buy” an item to indicate his or her support for a feature/function. A user may “sell” an item to decrease support or show a negative opinion regarding a feature/function. A degree to quantity by which a user buys or sells an idea may be used to represent the strength of the user's opinion (e.g., strongly like a feature, strongly dislike a feature, like a feature, indifferent toward a feature, etc.).

In certain embodiments, a user may be allowed to provide a certain amount of feedback (e.g., a user may be allocated a certain number of virtual “currency” for use in trading of ideas) to allocate among the traded ideas as the user desires. In other embodiments, no limit is placed on a user's ability to trade ideas on the market.

The market 120 accepts user input via the user interface 110 (and possibly from the back end processor 130 as well) and uses the input to modify market data according to one or more rules in place for the market 120. Rules may be provided as defaults and/or provided as input from one or more administrators, developers, and/or users, for example. Data is processed by the market 120 and made available for display, storage, transfer, and/or further processing via the user interface 110 and/or back end 130.

The back end processor 130 receives data from the market 120 relating to items being traded on the market 120, analysis data, and/or other user input, for example. The back end 130 may use market data to provide feedback and/or other input to software development, packaging and/or marketing, for example. For example, status and/or analysis output from the market 120 may be used to guide clinical software developers in providing feature(s)/functionality to customers (and/or specific group(s) of customers).

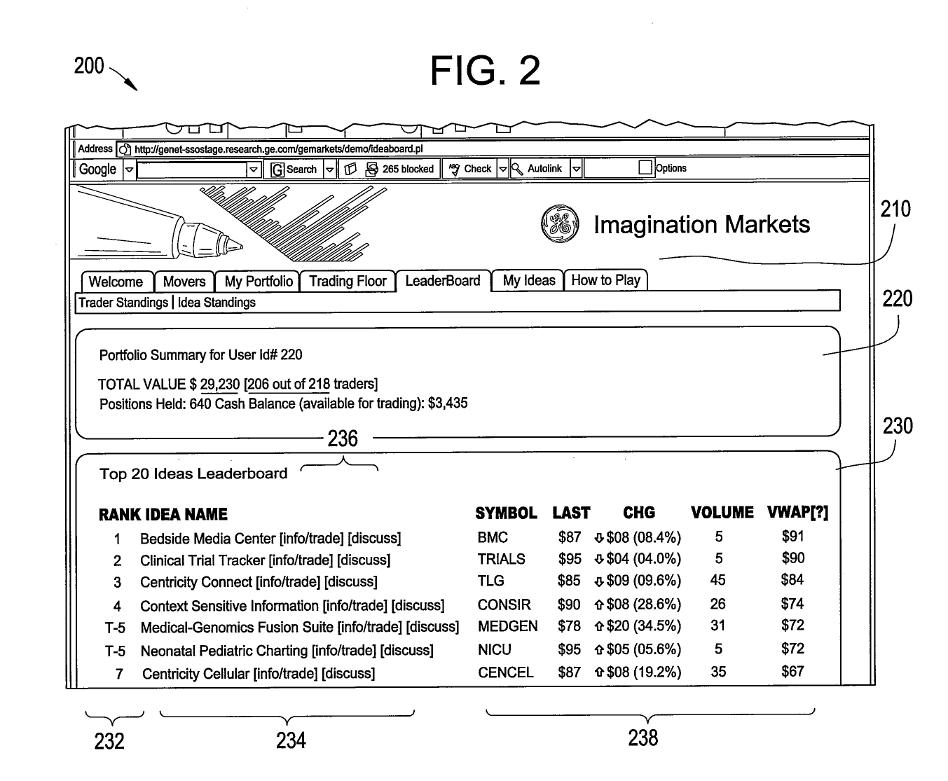

FIG. 2 illustrates an exemplary user interface display 200 for market-based evaluation of software features in accordance with an embodiment of the present invention. The interface 200 includes one or more tabs 210, a user summary 220, and market information 230, for example.

One or more tabs 210 provide various options for a user. For example, a movers tab may provide information regarding rapidly changing options. A portfolio tab may show a user which items are being tracked or opined upon by the user. A tracking floor tab allows a user to provide an opinion/trade a feature/function. A leaderboard tab provides the user with information regarding a certain number of top ideas being traded. Tabs may also provide information regarding user-submitted ideas (e.g., features/functionality), frequently asked questions (FAQs), rules, help information, customer support, etc.

The user summary 220 provides information such as a total value of a user's “assets” (e.g., a total amount of opinions given), a user's trading rank, a number of positions/opinions held, a cash balance available for further trading (e.g., an amount of feedback that the user is allowed to give), etc. In certain embodiments, a user, a group of users, and/or all users may be limited to a certain amount of feedback, for example.

The market information area 230 provides information regarding items being traded. The information area 230 includes one or more ideas 234, idea rank 232, one or more operations 236 (e.g., discuss, trade, information, etc.) to be applied to the ideas 234, market information 238 (e.g., trading symbol, last value, change, volume, volume weighted average price (VWAP), etc.) for the ideas 234, etc. A user may monitor idea market status based on information provided in the area 230, for example. A user may also facilitate interaction with the market via functions available in the area 230, for example.

Previously, information markets have only been used to measure customer preferences and predict continuous measures. QFDs are currently used as static documents, completed at a set point in time prior to a software development cycle and captured by surveys and interviews. Certain embodiments provide an extension of preference markets for use as continuous real-time QFDs, where QFD importance is derived from trading behavior and market prices.

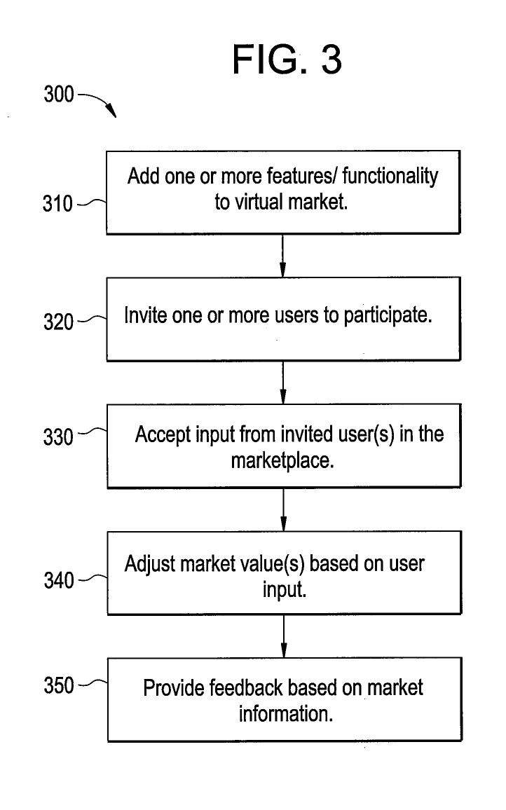

FIG. 3 illustrates a flow diagram for a method 300 for ranking software features/functionality using an information market in accordance with an embodiment of the present application. At step 310, one or more features/functionality may be added to a virtual information market. For example, software capabilities such as clinical trial tracking, pediatric charting, context sensitive information, etc., are added to the virtual market for trading.

At step 320, one or more users are invited to participate or trade in the market. For example, one or more eligible clinicians are invited to provide feedback to one or more software providers through trading on the information market.

At step 330, input from the invited users is accepted in the market framework. For example, one or more of the trading clinicians buy, sell, comment, and/or add one or more clinical software features/functionality. In certain embodiments, users may be allotted a finite amount of trading currency with which to provide feedback through trading on the market. In certain embodiments, for example, users may purchase, trade, and/or otherwise become eligible for additional feedback. In certain embodiments, an available amount of feedback (e.g., virtual trading currency) may vary for particular users and/or groups of users, for example.

At step 340, market values or one or more items representing features/functionality are adjusted based on the user input. For example, as one or more items are bought, sold, and/or added in the market, share price, and accordingly relative rank or importance, for the item(s) is adjusted based on trading activity. In certain embodiments, items may be added and/or removed by one or more users and/or systems based on one or more rules market parameters. In certain embodiments, one or more rules may limit a number of ideas to be traded on the market at one time.

At step 350, feedback is provided to an external or back-end system regarding feature/functionality ranking and/or other market status information. For example, a ranking of features/functionality may be provided to a software developer system for use in development, marketing and/or packaging of clinical software. As another example, one or more of trading frequency, change in market value, share price, trading volume, VWAP, etc., may be provided to an external system for use in software development, updating, marketing, packaging, etc. Feedback may be provided automatically and/or upon request, for example. Feedback may be provided at a close of trading, after a particular interval, on a recurring basis, etc. In certain embodiments, feedback may be provided for an operator/programmer in a variety of forms, such as logs, database information, alerts, electronic messages, documentation, etc. Alternatively and/or in addition, feedback may be provided to an electronic processing system for use in software development, for example.

In certain embodiments, a discussion board and/or other forum may be provided to allow users to discuss ideas as well as trade on those ideas. Discussion and/or trading may be anonymous, for example.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Certain embodiments provide an information market system for evaluating ideas relating to clinical functionality. For example, a virtual market facilitates evaluation of ideas relating to clinical functionality through trading of ideas by one or more authorized users. A user interface allows an authorized user to trade shares of clinical ideas to indicate an opinion regarding the ideas. In certain embodiments, user opinions may be weighted based on a starting number of shares, amount of trading currency, etc. In certain embodiments, one or more ideas may be seeded to start trading on the market. Users receive a starting number of shares for ideas on the market. One or more users may add further ideas for trading on the virtual market. In certain embodiments, submitted ideas are reviewed based on one or more rules and/or human review before the ideas are listed on the marketplace for trading. Users receive a starting number of shares for new ideas added to the market, for example. In certain embodiments, one or more ideas may be removed from the virtual market during trading based at least in part on addition of new ideas and a level of trading of ideas one the market. In certain embodiments, the virtual market may be subdivided into a plurality of sub-markets based on one or more criteria, for example.

Thus, certain embodiments provide a feedback tool that allows a potentially large, geographically dispersed customer base to provide information to software vendors regarding the relative importance of features and functionality. Certain embodiments allow customers to consider importance of individual features within the context of the importance of those features to other users. Certain embodiments allow a software vendor to assign particular weight or priority to opinions of one or more select subsets of the end-users, based on one or more criteria such as annual sales, expertise and/or other differentiating factor. Certain embodiments provide a technical effect of generating feedback regarding one or more features/functionality for use in software development via a market-based trading model.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any clinical software feedback system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A method for gathering user feedback regarding a plurality of clinical software options in a virtual market model, said method comprising:
allowing a plurality of authorized users to each submit one or more clinical software items to form a plurality of clinical software items for trading in a virtual market;
facilitating trading of said plurality of clinical software items by at least said plurality of authorized users via said virtual market; and
generating feedback regarding a relative popularity of said plurality of clinical software items based on comparative trading data for each of said plurality of clinical software items.

2. The method of claim 1, wherein said plurality of clinical software items comprises at least one of software feature and software functionality.

3. The method of claim 1, wherein said trading comprises at least one of buying, sell and adding one or more of said plurality of clinical software items in said virtual market.

4. The method of claim 1, further comprising allotting an amount of allowable feedback as virtual trading currency to each authorized user in the virtual market.

5. The method of claim 1, further comprising grouping said authorized users into one or more groups for organization of software feedback.

6. The method of claim 1, further comprising ranking said plurality of clinical software items based on trading data.

7. The method of claim 1, further comprising modifying at least one of software development and packaging based on said feedback.

8. The method of claim 1, further comprising approving a clinical software item submitted by an authorized user for trading in said virtual market prior to a start of trading of the clinical software item.

9. The method of claim 1, wherein said allowing step further comprises allowing one or more authorized users to submit one or more clinical software items for trading in said virtual market prior to commencement of or during trading of items in said virtual market.

10. The method of claim 1, further comprising delisting a clinical software item from trading in said virtual market based on a comparison of relative share price.

11. The method of claim 1, wherein a volume-weighted-average-price of shares traded for a software item indicates a relative importance of said software item to said authorized users.

12. A virtual market trading system for evaluating clinical software features and functionality, said system comprising:
a virtual market facilitating trading of one or more clinical software items by one or more authorized users; and
a user interface allowing an authorized user to submit one or more software items for trading via said virtual market and allowing said authorized user to trade shares of said one or more clinical software items to indicate an opinion regarding a relative value of said one or more clinical software items.

13. The system of claim 12, further comprising a back-end subsystem receiving feedback from said virtual market regarding said one or more clinical software items based on trading data and facilitating modification of at least one of clinical software development and packaging based on said feedback.

14. The system of claim 12, further comprising a user account, wherein each user account is allotted a certain amount of feedback as virtual trading currency for trading shares of one or more clinical software items on the virtual market.

15. The system of claim 12, wherein said one or more clinical software items comprises at least one of software feature and software functionality.

16. The system of claim 12, wherein said market groups said one or more authorized users into one or more groups for organization of software feedback.

17. The system of claim 12, wherein said market ranks said one or more clinical software items based on trading data.

18. The system of claim 12, wherein said user interface allows a user to submit one or more software items for trading via said virtual market prior to commencement of or during trading of items in said virtual market.

19. The system of claim 12, further comprising a back-end subsystem approving a clinical software item submitted by an authorized user for trading in said virtual market prior to a start of trading of the clinical software item.

20. The system of claim 12, wherein said virtual market is capable of delisting a clinical software item from trading in said virtual market based on a comparison of relative share price.

21. The system of claim 12, wherein a volume-weighted-average-price of shares traded for a software item indicates a relative importance of said software item to said one or more authorized users.

22. A computer-readable medium having a set of instructions for execution on a computer, said set of instructions comprising:
a virtual market trading routine providing one or more clinical software items for trading in a virtual market and facilitating trading of said one or more clinical software items by one or more authorized users via said virtual market;
a user interface routine allowing said one or more authorized users to trade shares of said one or more clinical software items and allowing said one or more authorized users to at least one of add and remove one or more clinical software items from said virtual market; and
a feedback routine generating feedback regarding said one or more clinical software items based on trading data.

23. The computer-readable medium of claim 22, further comprising a user account routine allotting an amount of allowable feedback as virtual trading currency to each authorized user in the virtual market.

24. The computer-readable medium of claim 22, wherein said feedback routine provides said one or more clinical software items trading at a volume-weighted-average-price above a certain threshold for use in at least one of software development and packaging.

25. An information market system for evaluating ideas relating to clinical functionality, said system comprising:
a virtual market facilitating evaluation of ideas relating to clinical functionality through trading of said ideas by one or more authorized users, wherein said ideas traded on said virtual market are submitted by said one or more authorized users; and
a user interface allowing an authorized user to submit ideas relating to clinical functionality and to trade shares of said ideas to indicate an opinion regarding a relative value of said ideas.

26. The system of claim 25, wherein said virtual market is initially seeded with at least one idea to begin trading, said at least one idea supplemented by said one or more authorized users during trading.

27. The system of claim 25, wherein one or more of said ideas are removed from said virtual market during trading based at least in part on at least one of addition of ideas and trading of ideas.
